(19) United States
(12) Patent Application Publication
(10) Pub. No.: US 2022/0163076 A1
(43) Pub. Date: May 26, 2022

(54) HYBRID DISK BRAKE PISTON SYSTEMS, METHODS OF MAKING SAID HYBRID SYSTEMS, AND METHODS OF USING SAID HYBRID SYSTEMS

(71) Applicant: Court Holdings Limited, Ontario (CA)

(72) Inventors: Mark FAWCETT, Grimsby (CA); Pawel PORADZISZ, Burlington (CA)

(73) Assignee: Court Holdings Limited, Ontario (CA)

(21) Appl. No.: 17/338,018

(22) Filed: Jun. 3, 2021

Related U.S. Application Data
(60) Provisional application No. 63/116,574, filed on Nov. 20, 2020.

(51) Int. Cl. F16D 55/226; F16D 65/092; F16D 65/18

(52) U.S. Cl. CPC F16D 55/226; F16D 2121/24; F16D 65/18; F16D 65/092

(57) ABSTRACT

Hybrid brake piston systems, methods of making hybrid brake piston systems and methods of using hybrid brake piston systems are provided. The hybrid disk brake piston systems have load bearing metal-based pressure pads and engineered resin-based outer bodies that are assembled using seal layouts and/or grooves. The metal-based pressure pads may be made from mild steel, stainless steel or aluminum and/or are designed and configured to contact both a spindle nut and a brake pad and to carry the load whilst under electronic parking activation. The resin-based outer bodies may be made of phenolic resin and/or are designed to move under hydraulic brake activation.

### CROSS REFERENCE TO RELATED APPLICATION

This application claims the benefit of U.S. Provisional Patent Application No. 63/116,574, filed Nov. 20, 2021, its entirety of which is hereby incorporated by reference into this application.

### TECHNICAL FIELD OF THE DISCLOSURE

The present disclosure pertains to the field of braking systems. More specifically, the present disclosure relates to hybrid brake pistons for mechanical brake caliper and/or electromechanical brake caliper. The present hybrid steel and engineered resin phenolic brake piston disclosed herein may reduce weight and/or may reduce or eliminate corrosion.

### BACKGROUND OF THE DISCLOSURE

During a standard brake apply in a disc brake system, hydraulic fluid is pressurized, which causes the brake pistons to move the brake pads against brake rotors. As a result a clamping force is created. The clamping force functions to decelerate and or restrict movement of the vehicle. By releasing the brake or apply, the clamp force is released and the fluid is depressurized. Accordingly, the brake pistons and brake pads move away from the brake rotor; once released, the vehicle is free to move again.

A parking brake system may utilize one or more components of the brake system to maintain a vehicle in a stopped or parked position. In modern applications, the parking brake systems may be mechanical or adopt an electromechanical system. Electromechanical parking brake systems includes a motor gear unit, spindle and nut adapted to move the brake pistons and brake pads against brake rotors to create a clamp force to maintain the vehicle in a stopped or parked position. To release the clamp force, the motor gear unit, spindle and nut mechanism moves away from the bake piston allowing the brake pistons and brake pads to release the brake rotors.

### SUMMARY OF THE DISCLOSURE

In some embodiments, a hybrid brake piston system is provided and may comprise a pressure pad made of a first material configured or designed to carry a load applied by a motor gear unit spindle and nut and to push against a brake pad, a piston body made of a second material and comprising an internal bore, wherein the second material of the piston body is a different material than the first material of the pressure pad, and seals maintaining the pressure pad and the piston body under tension and providing a sealing surface between the pressure pad and the piston body.

In an embodiment, the first material may be a metal-based material and the second material may be resin-based material.

In an embodiment, the metal-based material may comprise steel, stainless steel, aluminum or another metal material and the resin-based material may comprise phenolic resin.

In an embodiment, the hybrid brake piston system may be a hybrid steel and engineered resin phenolic disk brake piston.

In an embodiment, the system may comprise seal grooves that are configured for receiving the seals and machined or formed into the internal bore or surface of the piston body or an outer surface or mating outside diameter of the pressure pad.

In an embodiment, the seals may be O-ring seals and O-ring seal grooves may be configured for receiving the O-ring seals and/or may be formed or disposed in the piston body or the pressure pad.

In an embodiment, the system may comprise seal grooves, configured for receiving the seals, may be formed into the internal bore of the piston body or onto an outer surface of the pressure pad at an angle with respect to the longitudinal axis of the piston body and/or the pressure pad.

In an embodiment, the angle of the seal grooves may be equal to about 90° or less than about 90°.

In an embodiment, the angle of the seal grooves may maximize sealing between the piston body and pressure pad and/or may retain the piston body and pressure pad assembled under tension.

In an embodiment, at least one first seal groove may be formed into the internal bore of the piston body or onto an outer surface of the pressure pad at a first angle with respect to the longitudinal axis of the piston body and/or the pressure pad and at least one second seal groove may be formed into the internal bore of the piston body or onto an outer surface of the pressure pad at a second angle with respect to the longitudinal axis of the piston body and/or the pressure pad.

In an embodiment, the first angle of the at least one first seal groove may be the same angle or a different angle than the second angle of the at least one second groove.

In an embodiment, at least one of the first angle and the second angle may be equal to about 90° or less than about 90°.

In an embodiment, the first angle may be a different angle than the second angle.

In some embodiments, methods may provide the hybrid brake piston system by assembling the pressure pad and piston body together.

In some embodiments, methods may apply, by a motor gear unit spindle and/or nut, a load onto the hybrid brake piston system.

In some embodiments, methods may push the pressure pad of the hybrid brake piston system against a brake pad.

In some embodiments, methods may apply at least one of hydraulic pressure, parking force and electronic activation torque onto the hybrid brake piston system.

In some embodiments, a disc brake caliper assembly is provided and may comprise the hybrid brake piston system.

In some embodiments, a vehicle is provided and may comprise the above-mentioned disc brake caliper assembly.

In other embodiments, the hybrid disk brake piston may comprise a pressure pad assembled to the engineered resin phenolic body using new and inventive seal layout, wherein the pressure pad may be the load bearing component designed and configured to apply load through the brake pads and the body may be the component that is slidably within the caliper bore and applies braking under hydraulic pressure.

In response to the actuation of the hydraulic brake system, the hybrid brake piston will slide within the caliper bore and apply braking pressure through the brake pads against the brake disk. The parking brake with an electromechanical brake system comprising a motor gear unit, spindle and nut, where the electric motor causes the spindle to rotate, forcing the spindle nut to engage the pressure pad which in turn forces the hybrid brake piston to apply force to the brake pad and brake disk.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1A is a cross-sectional view of an assembled hybrid brake piston with double seal design machined, formed, or disposed into piston body, facing hydraulic pressure flow, according to one or more examples of the disclosure.

FIG. 1B is a cross-sectional view of an assembled hybrid brake piston with double seal design machined, formed, or disposed into piston body, facing away from hydraulic pressure flow, according to one or more examples of the disclosure.

FIG. 1C is a cross-sectional view of an assembled hybrid brake piston with double seal design machined, formed, or disposed into piston body, facing both away and into hydraulic pressure flow, in a V-formation, according to one or more examples of the disclosure.

FIG. 1D is a cross-sectional view of an assembled hybrid brake piston with double seal design machined, formed, or disposed into pressure pad, facing away from hydraulic pressure flow, according to one or more examples of the disclosure.

FIG. 1E is a cross-sectional view of an assembled hybrid brake piston with double seal design machined, formed, or disposed into pressure pad, facing hydraulic pressure flow, according to one or more examples of the disclosure.

FIG. 1F is a cross-sectional view of an assembled hybrid brake piston with double seal design machined, formed, or disposed into pressure pad, facing both away and into hydraulic pressure flow, in a V-formation, according to one or more examples of the disclosure.

FIG. 2A is an exploded view of a hybrid brake piston with double seal design machined, formed, or disposed into piston body, facing hydraulic pressure flow, according to one or more examples of the disclosure.

FIG. 2B is an exploded view of a hybrid brake piston with double seal design machined, formed, or disposed into piston body, facing away from hydraulic pressure flow, according to one or more examples of the disclosure.

FIG. 2C is an exploded view of a hybrid brake piston with double seal design machined, formed, or disposed into piston body, facing both away and into hydraulic pressure flow, in a V-formation, according to one or more examples of the disclosure.

FIG. 2D is an exploded view of a hybrid brake piston with double seal design machined, formed, or disposed into pressure pad, facing away from hydraulic pressure flow, according to one or more examples of the disclosure.

FIG. 2E is an exploded view of a hybrid brake piston with double seal design machined, formed, or disposed into pressure pad, facing hydraulic pressure flow, according to one or more examples of the disclosure.

FIG. 2F is an exploded view of a hybrid brake piston with double seal design machined, formed, or disposed into pressure pad, facing both away and into hydraulic pressure flow, in a V-formation, according to one or more examples of the disclosure.

FIG. 3A is a perspective view of a hybrid brake piston body, according to one or more examples of the disclosure.

FIG. 3B is a perspective view of a hybrid brake piston body, according to one or more examples of the disclosure.

FIG. 4A is a perspective view of a hybrid brake piston pressure pad, according to one or more examples of the disclosure.

FIG. 4B is a perspective view of a hybrid brake piston pressure pad, according to one or more examples of the disclosure.

FIG. 5 is a perspective view of a hybrid bake piston seal, according to one or more examples of the disclosure.

FIG. 6 is a perspective view of a hybrid brake piston, according to one or more examples of the disclosure.

FIG. 7 is a perspective view of a disc brake caliper assembly comprising the hybrid brake piston, according to one or more examples of the disclosure.

### DETAILED DESCRIPTION

Illustrative examples of the subject matter claimed below will now be disclosed. In the interest of clarity, not all features of an actual implementation are described in this specification. It will be appreciated that in the development of any such actual implementation, numerous implementation-specific decisions may be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

Further, as used herein, the article “a” is intended to have its ordinary meaning in the patent arts, namely “one or more.” Herein, the term “about” when applied to a value generally means within the tolerance range of the equipment used to produce the value, or in some examples, means plus or minus 10%, or plus or minus 5%, or plus or minus 1%, unless otherwise expressly specified. Further, herein the term “substantially” as used herein means a majority, or almost all, or all, or an amount with a range of about 51% to about 100%, for example. Moreover, examples herein are intended to be illustrative only and are presented for discussion purposes and not by way of limitation.

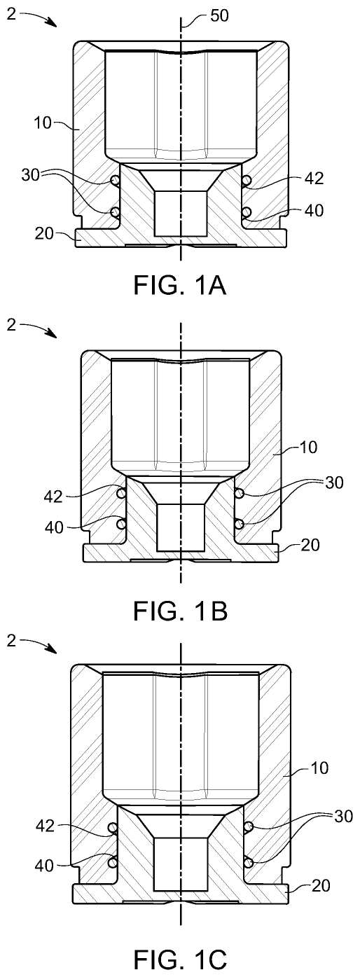

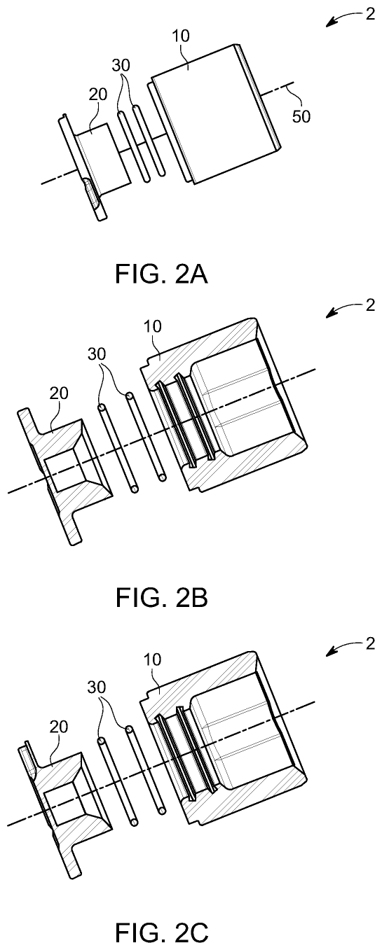

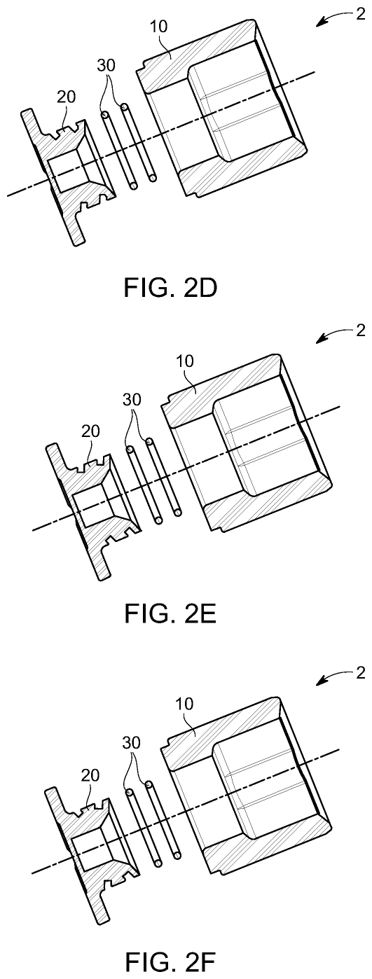

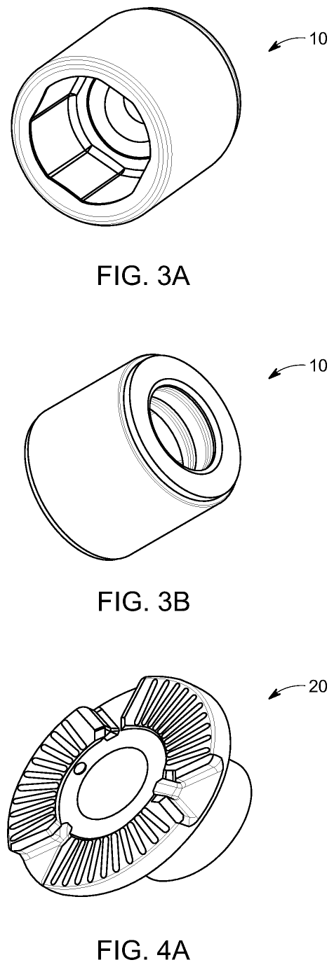

The present hybrid brake system disclosed herein may comprise a brake caliper with a single or multiple bores, to accommodate a slidable hybrid brake piston 2 (hereinafter “the hybrid brake piston 2”) located within the bore. The hybrid brake piston 2 comprises an engineered resin phenolic body 10 (as shown in FIGS. 3A and 3B; hereinafter “the body 10”), at least one of pressure pad 20 (as shown in FIGS. 4A and 4B; hereinafter “the pad 20”), and at least two oil seals 30 (as shown in FIG. 5). The engineered resin phenolic body 10 may be assembled over the pressure pad 20 and the two components (i.e., body 10 and pad 20) may be retained in place by the at least two oil seals 30 (as shown in FIGS. 1A-1F) to produce, provide, and/or assemble the hybrid brake piston 2.

At least two oil seal grooves 40, 42 may be provided in the body 10 (as shown in FIGS. 1A-1C) and/or the pad 20 (as shown in FIGS. 1D-1F) and/or may be sized, shaped, configured, and/or adapted to receive the at least two oil seals 30. The at least two oil seal grooves 40, 42 may be provided at an angle with respect to the longitudinal axis 50 of the body 10, the pad 20, and/or the hybrid brake system. The angle of the at least two oil seal grooves 40, 42 are designed to give both maximum sealing between the two components (i.e., body 10 and pad 0) and retain the body 10 and the pad 20 under tension.

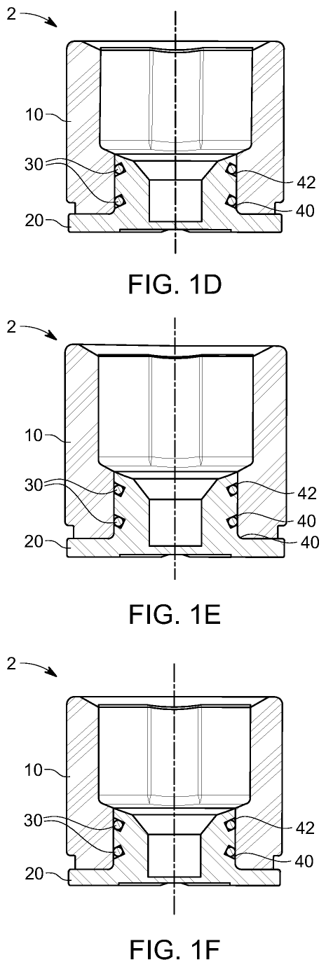

In embodiments, the angle of the at least two oil seal grooves 40, 42 may be equal to about 90°, greater than about 90°, or less than about 90°. In an embodiment, the angle of the at least two oil seal grooves 40, 42 may be equal to or less than about 90°. In some embodiments, a first oil seal groove 40 of the at least two oil seal grooves 40, 42 may be provided at a first angle with respect to the longitudinal axis 50 of the body 10, the pad 20, and/or the hybrid brake system and a second oil seal groove 42 of the at least two oil seal grooves 40, 42 may be provided at a second angle with respect to the longitudinal axis 50 of the body 10, the pad 20, and/or the hybrid brake system. The first angle and/or the second angle may be equal to about 90°, greater than about 90°, or less than about 90°. In an embodiment, the first and second angles may be equal to or less than about 90°. Moreover, the first angle may be the same angle or a different angle than the second angle, as shown in FIGS. 1A-1F and 2A-2F.

The present hybrid brake systems disclosed herein may utilize hydraulic fluid pressure to cause the hybrid brake piston 2 (comprising the body 10, the pad 20, and the at least two oil seals 30 to slide within the bore and apply pressure onto the brake pad and push the brake pads against the brake rotor. The present hybrid brake systems disclosed herein may utilize the hybrid brake piston 2 with both hydraulic pressure for braking and mechanical or electromechanical as a means of activation of the parking brake system comprising of spindle nut and a spindle screw driven by the electric motor.

The present parking hybrid brake systems disclosed herein may utilize the electric motor to cause the spindle screw to rotate and move the spindle nut in a linear motion. Once the spindle nut contacts the pressure pad, the applied force moves the hybrid brake piston against the brake pad and rotor and applies the packing brake.

The hybrid brake piston 2 disclosed herein may be designed, configured, adapted, shaped, and/or sized to accommodate all types of brake calipers. As a result, one advantage of the present design disclosed herein may be weight reduction and/or mass reduction. Thermal installation may be another advantage, through the use of engineered resin phenolic, thermal installation may be improved. Other benefits by using stainless steel pressure pad will be a corrosion resistant hybrid brake piston.

In some embodiments, the hybrid brake piston is a hybrid steel and engineered resin phenolic disk brake piston that may comprise:

the pressure pad 20 (designed to carry the load applied by the motor gear unit spindle and nut and push against the brake pad) that may be made from mild steel, stainless steel, aluminum or other metal-based material;

the piston body 10 that may be made of different material to pressure pad 20, such as, for example engineered resin phenolic; and

the at least two seals 30 which may maintain the pressure pad and piston body under tension and provide a sealing surface between the two main components (i.e., the body 10 and pad 20).

In an embodiment, the at least two seal grooves 40, 42 may be machined into the internal bore of the body 10 and/or in the form of O-ring sealing grooves.

In other embodiments, the present hybrid steel and engineered resin phenolic disk brake pistons may comprising:

the pressure pad 20 (designed to carry the load applied by the motor gear unit spindle and nut and push against the brake pad) which may be made from mild steel, stainless steel, aluminum or other material;

the body 10 which may be made of different material to pressure pad, such as, for example, engineered resin phenolic; and

the at least two seals 30 which may maintain the pressure pad and piston body under tension and provide a sealing surface between the two main components (i.e., the body 10 and pad 20).

In an embodiment, the at least two seal grooves 40, 42 may be machined into the pressure pad mating outside diameter and/or in the form of O-ring sealing grooves. Moreover, the at least seal grooves 40, 42 are designed or machined at the angle, or at the first and second angles, which may provide both maximum sealing between the two components (i.e., the body 10 and pad 20) and retain the assembled components (i.e., the body 10 and pad 20) under tension.

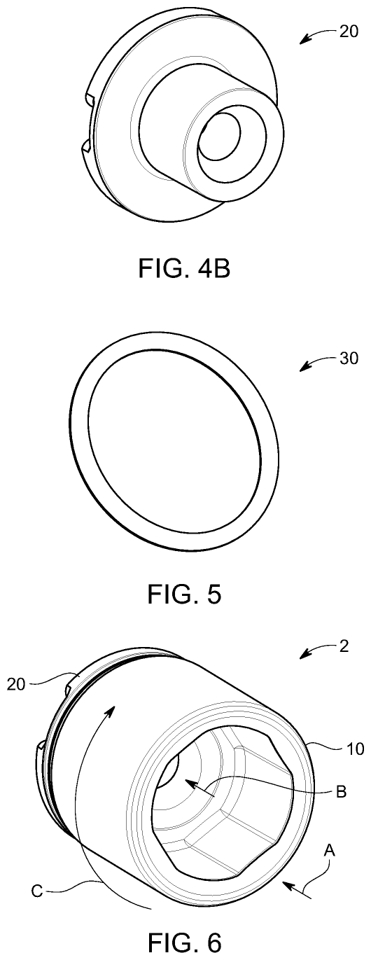

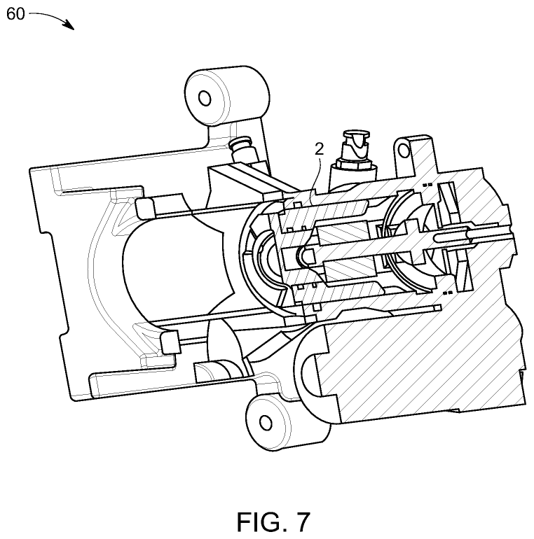

As shown in FIG. 6, the hybrid brake piston 2 comprises the body 10, the pad 20, and the at least two oil seals 30 and forms at least a portion of a hybrid electronic parking brake caliper piston (hereinafter “H-EPB”). The present H-EPB disclosed herein comprises the hybrid brake piston 2 and is capable of withstanding one or more predetermined or predefined requirements and/or parameters, such as, for example, a hydraulic pressure (illustrated by arrow A), a parking force (illustrated by arrow B) and/or an electronic activation torque (illustrated by arrow C). The present H-EPB disclosed herein provides a light weight, a corrosion resistant and/or a heat blocking alternative to known steel electronic parking brake (hereinafter “EPB”) caliper pistons.

In some embodiments, the hybrid brake piston 2 may be a phenolic hybrid caliper brake piston that may be designed or configured to be driven by a spindle nut, whereby the load may be applied through a pressure base which applies load against the brake pad. The steel, aluminum or stainless-steel pressure base may be assembled to a phenolic piston body. The assembly may include at least one new- and inventive-designed seal angle to maintain tension between the piston pressure base (i.e., the body 10) and piston body (i.e., the pad 20) and/or to provide a leak proof seal. The hybrid brake piston 2 may provide lower weight, reduce heat conductivity and zero corrosion alternative to steel pistons.

In some embodiments, the hybrid brake piston 2 disclosed herein comprise at least the body 10, the pad 20, the at least two oil seal grooves 40, 42 provided in the body 10 and/or the pad 20, and the two oil seals 30 as shown in FIGS. 1A-1F and 2A-2F. For example, the body 10 may be made from a phenolic material (which may be molded and/or machined) and the pad 20 may be made from a stainless steel material (which may be a backward extrusion and/or machined). Additionally, the at least two oil seals 30 may maintain brake fluid under pressure and an anti-rotation feature may be designed, configured, and/or shaped to receive or correspond to one or more internal components of a known EPB caliper piston or the one or more components of the present H-EPB disclosed herein.

In some embodiments, a disc brake caliper assembly 60 may comprise at least one of the hybrid brake piston 2 as disclosed herein.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific examples are presented for purposes of illustration and description. They are not intended to be exhaustive of or to limit this disclosure to the precise forms described. Obviously, many modifications and variations are possible in view of the above teachings. The examples are shown and described in order to best explain the principles of this disclosure and practical applications, to thereby enable others skilled in the art to best utilize this disclosure and various examples with various modifications as are suited to the particular use contemplated. It is intended that the scope of this disclosure be defined by the claims and their equivalents below.

What is claimed is:

1. A hybrid brake piston system comprising:
a pressure pad made of a first material configured or designed to carry a load applied by a motor gear unit spindle and nut and to push against a brake pad;
a piston body made of a second material and comprising an internal bore, wherein the second material of the piston body is a different material than the first material of the pressure pad; and
seals maintaining the pressure pad and the piston body under tension and providing a sealing surface between the pressure pad and the piston body.

2. The hybrid brake piston system of claim 1, wherein the first material is a metal-based material and the second material is resin-based material.

3. The hybrid brake piston system of claim 2, wherein the metal-based material comprises steel, stainless steel, aluminum or another metal material and the resin-based material comprises phenolic resin.

4. The hybrid brake piston system of claim 1, wherein the hybrid brake piston system is a hybrid steel and engineered resin phenolic disk brake piston.

5. The hybrid brake piston system of claim 1, further comprising:
seal grooves configured for receiving the seals and machined or formed into the internal bore or a surface of the piston body or an outer surface or mating outside diameter of the pressure pad.

6. The hybrid brake piston system of claim 1, wherein the seals are O-ring seals and O-ring seal grooves configured for receiving the O-ring seals are formed or disposed in the piston body or the pressure pad.

7. The hybrid brake piston system of claim 1, further comprising:
seal grooves, configured for receiving the seals, are formed into the internal bore of the piston body or onto an outer surface of the pressure pad at an angle with respect to a longitudinal axis of the piston body and/or the pressure pad.

8. The hybrid brake piston system of claim 7, wherein the angle of the seal grooves are equal to about 90° or less than about 90°.

9. The hybrid brake piston system of claim 7, wherein the angle of the seal grooves maximizes sealing between the piston body and pressure pad and/or retains the piston body and pressure pad assembled under tension.

10. The hybrid brake piston system of claim 1, further comprising:
at least one first seal groove are formed into the internal bore of the piston body or onto an outer surface of the pressure pad at a first angle with respect to the longitudinal axis of the piston body and/or the pressure pad; and
at least one second seal groove are formed into the internal bore of the piston body or onto an outer surface of the pressure pad at a second angle with respect to the longitudinal axis of the piston body and/or the pressure pad,
wherein the first angle of the at least one first seal groove is the same angle or a different angle than the second angle of the at least one second groove.

11. The hybrid brake piston system of claim 10, wherein at least one of the first angle and the second angle are equal to about 90° or less than about 90°.

12. The hybrid brake piston system of claim 10, wherein the first angle is a different angle than the second angle.

13. A method comprising:
providing the hybrid brake piston system of claim 1 by inserting the pressure pad into the piston body to assemble the pressure pad and the piston body together.

14. The method of claim 13, further comprising:
applying, by a motor gear unit spindle and/or nut, a load onto the hybrid brake piston system.

15. The method of claim 13, further comprising:
pushing the pressure pad of the hybrid brake piston system.

16. The method of claim 13, further comprising:
applying at least one of hydraulic pressure, parking force and electronic activation torque onto the hybrid brake piston system.

17. A disc brake caliper assembly for a vehicle comprising:
the hybrid brake piston system of claim 1.
